(19) United States
(12) Patent Application Publication
(10) Pub. No.: US 2007/0188529 A1
(43) Pub. Date: Aug. 16, 2007

(54) Liquid detection device, liquid container and liquid ejection apparatus

(75) Inventor: Junhua Zhang, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/656,857

(22) Filed: Jan. 22, 2007

(30) Foreign Application Priority Data
Jan. 20, 2006 (JP) 2006-012909
Jan. 17, 2007 (JP) 2007-007939

(51) Int. Cl. B41J 2/195; B41J 29/393; B41J 2/175

(52) U.S. Cl. 347/7; 347/19; 347/85

(57) ABSTRACT

A liquid detection device that is accommodated in a sensor accommodating portion formed in a liquid container containing a liquid therein and detects the liquid in the liquid container using a piezoelectric element, wherein, when a wavelength of a vibration wave to be emitted from the piezoelectric element is λ, a distance H from a rear surface of a vibration wave emitting surface of the piezoelectric element to a wall surface facing the rear surface is represented by Equation 1.
(n×λ/2−λ/4−λ/8)≦H≦(n×λ/2−λ/4+λ/8) (Equation 1) (where n=1, 2, 3, . . . )

### BACKGROUND

1. Technical Field

The present invention relates to a liquid detection device, and in particular, to a liquid detection device that is applied to a liquid ejection apparatus, such as an ink jet recording apparatus so as to primarily detect an ink residual quantity.

2. Related Art

As a representative one of known liquid ejection apparatuses, there is an ink jet recording apparatus that has an ink jet recording head for image recording. Other liquid ejection apparatuses include, for example, an apparatus having a color material jetting head used in manufacturing color filters of a liquid crystal display or the like, an apparatus having an electrode material (conductive paste) jetting head used in forming electrodes of an organic electroluminescent (EL) display or a surface emission display (FED), an apparatus having a bioorganic compound jetting head used in manufacturing a bio-chip, an apparatus having a sample spraying head as a precision pipette, and so on.

In the ink jet recording apparatus, which is the representative one of the liquid ejection apparatuses, an ink jet recording head has a pressure generating unit for pressurizing a pressure generation chamber and nozzle openings for ejecting pressurized ink as ink droplets. Then, the ink jet recording head is mounted on a carriage. In addition, ink in an ink container is supplied to the recording head through a flow passage in succession, such that printing is continuously performed. The ink container is a detachable cartridge that can be simply replaced by a user when ink is consumed.

As a method of managing ink consumption of the ink cartridge, there is a method that manages ink consumption by totalizing the number of ejections of ink droplets from the recording head or an ink amount absorbed through maintenance using software so as to calculate ink consumption, or a method that manages a time, at which ink is actually consumed by a predetermined amount, by attaching liquid level detection electrodes to the ink cartridge.

However, the method that manages ink consumption by the calculation of totalizing the number of ejections of the ink droplets or the ink amount using software has the following problems. Of the heads, there are those having a weight variation between ejected ink droplets. The weight variation between the ink droplets does not have an effect on image quality. However, since the ink cartridge is filled with ink in an amount with a margin, taking into consideration of cumulative ink consumption errors due to the variations, there is a problem in that, in some cases, ink remains by the amount corresponding to the margin.

Meanwhile, the method of managing by the electrodes the time, at which ink is consumed, can detect the actual amount of ink, and thus the ink residual quantity can be managed with high reliability. However, this method relies upon conductivity of ink in detecting the liquid level of ink, and thus it has a defect that kinds of detectable ink are limited or an electrode seal structure is complicated. Further, the electrode usually uses a precious metal having good conductivity and high corrosion resistance, and thus manufacturing costs of the ink cartridge may be increased. In addition, since two electrodes need to be attached, the number of manufacturing steps is increased, and thus manufacturing costs are increased.

As one of apparatuses that have been developed in order to solve such a problem, a piezoelectric device (herein, referred to as a liquid detection device) is disclosed in Patent Document 1. The liquid detection device monitors the ink residual quantity in the ink cartridge using the fact that a resonant frequency of a residual vibration signal changes due to residual vibration (free vibration) of a vibrating plate after compulsory vibration between the cases of a presence of ink in a cavity facing the vibrating plate having laminated thereon a piezoelectric element and of an absence of ink therein.

Patent Document 1: JP-A-2001-146030

However, when the liquid detection device described in Patent Document 1 is used, ink needs to freely enter the cavity facing the vibrating plate, but not to enter the side on which electrical parts, such as the piezoelectric element and so on, are disposed. For this reason, upon attaching, adjacent members need to be closely sealed.

The seal structure include a structure that directly attaches the liquid detection device to an edge of an opening of a container main body (cartridge main body) and a structure that directly attaches the liquid detection device to an edge of an opening of a module and then attaches the module to the container main body through an O ring. However, in these structures, since the liquid detection device is adhered to the edge of the opening, if a variation in size exists, it is difficult to secure sealability. Further, if the liquid detection device is directly adhered to the edge of the opening of the container main body or the edge of the opening of the module, it is likely to be influenced by ink waves or bubbles in ink, and thus erroneous detection may occur.

In an ink residual quality detection container that has the liquid detection device including the piezoelectric element and the vibrating plate, upper portions of the piezoelectric element and the vibration plate are covered with a unit cover. Accordingly, if a gap between the cover and the piezoelectric element or the vibrating plate is excessively small, a counter electromotive signal is attenuated due to a reflected wave from the cover, and thus the ink residual quantity cannot be accurately detected.

### SUMMARY

The invention has been finalized in view of the above problems, and it is an object of the invention to provide a liquid detection device that can simply and reliably perform sealing when a liquid detection device is attached to a container main body with no effect by size accuracy of parts, and can perform accurate detection of an ink residual quantity with no effect by ink waves or bubbles in ink and with small vibration attenuation by a reflected wave of a piezoelectric element or a vibrating plate.

According to a first aspect of the invention, a liquid detection device that is accommodated in a sensor accommodating portion formed in a liquid container containing a liquid therein and detects the liquid the liquid in the liquid container using a piezoelectric element, wherein when a wavelength of a vibration wave to be emitted from the piezoelectric element is λ, a distance H from a rear surface of a vibration wave emitting surface of the piezoelectric element to a wall surface facing the rear surface is represented by Equation 1.
(n×λ/2−λ/4−λ/8)≦H≦(n×λ/2−λ/4+λ/8) (Equation 1)
(where n=1, 2, 3, . . . )

According to a second aspect of the invention, a liquid detection device that is accommodated in a sensor accommodating portion formed in a liquid container containing a liquid therein and detects the liquid the liquid in the liquid container using a piezoelectric element, wherein an opening that is larger than at least an external shape of the piezoelectric element is provided at a wall surface facing a rear surface of a vibration wave emitting surface of the piezoelectric element.

According to a third aspect of the invention, there is provided a liquid detection device that is connected to a liquid containing portion containing a liquid therein and detects the liquid in the liquid containing portion using a piezoelectric element. The liquid detection device includes a sensor cavity that receives the liquid, a vibrating plate that closes an opening of the sensor cavity, and a piezoelectric element that is provided at a surface of the vibrating plate opposite to the sensor cavity. A wall surface facing a rear surface of a vibration wave emitting surface of the piezoelectric element is provided. When a wavelength of a vibration wave to be emitted from the piezoelectric element is λ, a distance H from the rear surface to the wall surface is represented by Equation 1.
(n×λ/2−λ/4−λ/8)≦H≦(n×λ/2−λ/4+λ/8) (Equation 1)
(where n=1, 2, 3, . . . )

According to a fourth aspect of the invention, there is provided a liquid detection device that is connected to a liquid containing portion containing a liquid therein and detects the liquid in the liquid containing portion using a piezoelectric element. The liquid detection device includes a sensor cavity that receives the liquid, a vibrating plate that closes an opening of the sensor cavity, and a piezoelectric element that is provided at a surface of the vibrating plate opposite to the sensor cavity. A wall surface facing a rear surface of a vibration wave emitting surface of the piezoelectric element is provided. An opening that is larger than at least an external shape of the piezoelectric element is provided at the wall surface.

According to the liquid detection device of each of the first to fourth aspects of the invention, there is little possibility that vibration of the piezoelectric element or the vibrating plate is attenuated by a reflected wave from the wall surface, and the reduction of a counter electromotive signal is prevented. Accordingly, accurate detection of a liquid residual quantity can be performed. In addition, the liquid detection device of the second or fourth aspect of the invention is effective when an installment space of the piezoelectric element is not enough and the distance H of Equation 1 cannot be secured. Further, even when the installment space of the piezoelectric element is temporarily enough, it is not necessary to secure the distance H of Equation 1. Accordingly, the installment space of the piezoelectric element can be made small, and a degree of freedom for an installment position thereof can be increased. As a result, the liquid detection device can be reduced in size, and a degree of freedom for installment of the liquid detection device can be increased.

The liquid detection device according to each of the first to fourth aspects of the invention can be used in a liquid container or a liquid ejection apparatus.

The liquid detection device according to the first or second aspect of the invention may further include a unit base to which the piezoelectric element is attached, and a sensor cover that presses the unit base into contact with a unit base receiving wall of the sensor accommodating portion by an urging unit. Further, a liquid container or a liquid ejection apparatus that uses the liquid detection device according to the third or fourth aspect of the invention may include a sensor accommodating portion that accommodates the liquid detection device, a unit base to which the piezoelectric element is attached, and a sensor cover that presses the unit base into contact with a unit base receiving wall of the sensor accommodating portion by an urging unit. With this configuration, the liquid detection device can be separately assembled in advance, and then the liquid detection device can be pressed by the urging unit and mounted on the liquid container or the liquid ejection apparatus. Accordingly, assembling when the liquid detection device is mounted on the liquid container or the liquid ejection apparatus can be simplified compared with a case where the liquid detection device is bonded to the liquid container or the liquid ejection apparatus. Further, the liquid detection device can be replaced. Moreover, when the above-described configuration is adopted, an inner surface of the sensor cover facing the piezoelectric element becomes the wall surface.

In the liquid detection device according to the first or second aspect of the invention, an inner surface of a wall of the sensor accommodating portion may become the wall surface facing the rear surface of the vibration wave emitting surface of the piezoelectric element. Further, a liquid container or a liquid ejection apparatus that uses the liquid detection device according to the third or fourth aspect of the invention may further include a sensor accommodating portion that accommodates the liquid detection device. A wall of the sensor accommodating portion may become the wall surface that faces a rear surface of a vibration wave emitting surface of the piezoelectric element.

The present disclosure relates to the subject matter contained in Japanese patent application Nos. 2.006-012909 filed on Jan. 20, 2006, and 2007-7939 filed on Jan. 17, 2007, which are expressly incorporated herein by reference in its entirety.

### BRIEF DESCRIPTION OF THE DRAWINGS

The invention will be described with reference to the accompanying drawings, wherein like numbers reference like elements.

FIG. 1 is a perspective view showing the schematic configuration of an ink jet recording apparatus (liquid ejection apparatus) that uses an ink cartridge according to an embodiment of the invention.

FIG. 2 is an exploded perspective view showing the schematic configuration of an ink cartridge according to the embodiment of the invention.

FIG. 3 is a cross-sectional view of a portion where a liquid detection device is incorporated into an ink cartridge according to the embodiment of the invention, as viewed from the front side.

FIG. 4 is an expanded cross-sectional view showing essential parts in a first embodiment of the invention.

FIG. 5 is a diagram showing the relationship between an outgoing wave and a reflected wave between a rear surface of a vibration wave emitting surface of a piezoelectric element and a wall surface facing the rear surface (distance H). FIG. 5A shows a case when the condition H=λ/2 is satisfied, and FIG. 5B shows a case when the condition H=λ/4 is satisfied.

FIG. 6 is an expanded cross-sectional view showing essential parts in a second embodiment of the invention, which corresponds to FIG. 4.

FIG. 7 is a schematic cross-sectional view showing a case where a liquid detection device according to a third embodiment of the invention is applied to an ink jet recording apparatus as a liquid consuming apparatus.

FIG. 8 is a diagram showing the operation states of the liquid detection device according to the third embodiment of the invention.

### DESCRIPTION OF EXEMPLARY EMBODIMENTS

Hereinafter, a liquid detection device according to each embodiment of the invention will be described with reference to the drawings.

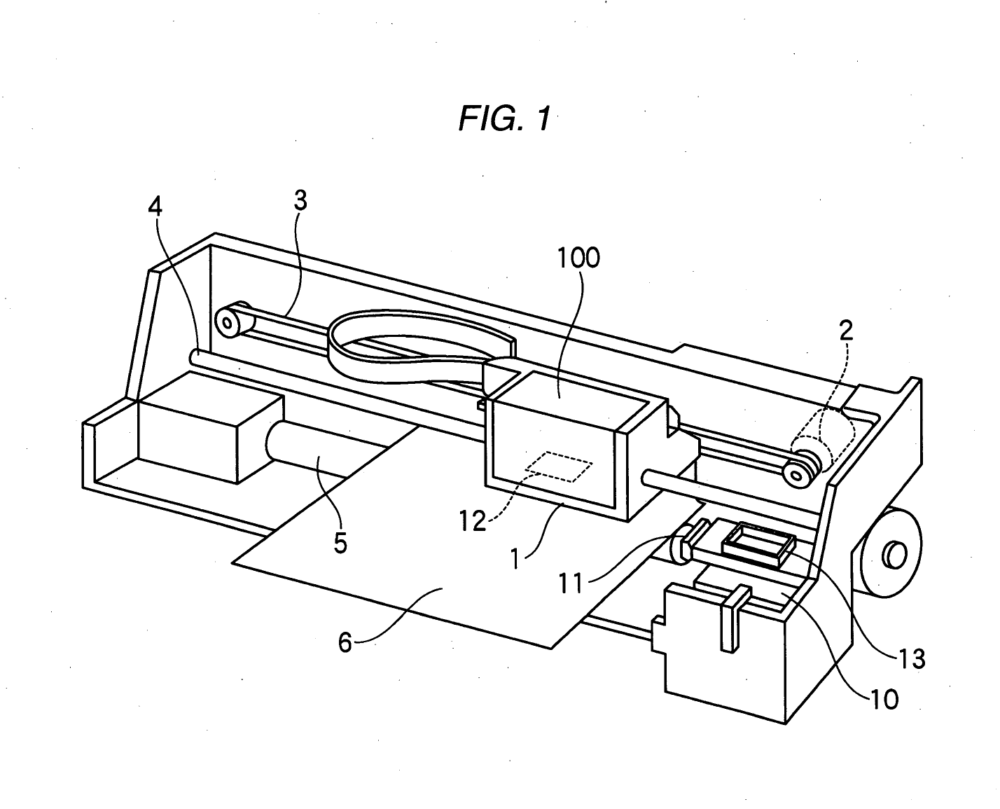

FIG. 1 shows the schematic configuration of an ink jet recording apparatus (liquid ejection apparatus) that uses an ink cartridge (liquid container) having a liquid detection device according to a first embodiment. In FIG. 1, reference numeral 1 denotes a carriage. The carriage 1 is guided by a guide member 4 and reciprocates in an axial direction of a platen 5 through a timing belt 3 that is driven by a carriage motor 2.

An ink jet recording head 12 is mounted on a side of the carriage 1 facing a recording paper 6, and an ink cartridge (liquid container) 100 that supplies ink to the recording head 12 is detachably mounted above the recording head 12.

A cap member 13 is disposed at a home position (a left side in the drawing) as a non-printing region of the recording apparatus. The cap member 13 is pressed into contact with a nozzle formation surface of the recording head 12 and forms a closed space with the nozzle formation surface when the recording head 12 mounted on the carriage 1 is moved to the home position. Then, a pump unit 10 that applies a negative pressure to the closed space formed by the cap member 13 so as to perform cleaning or the like is disposed below the cap member 13.

In the periphery of the cap member 13 close to a printing region, a wiping unit 11 having an elastic plate, such as rubber, is disposed to advance and retreat, for example, in a horizontally front and rear direction with respect to the movement trace of the recording head 12. If necessary, when the carriage 1 reciprocates toward the cap member 13, the wiping unit 11 wipes the nozzle formation surface of the recording head 12.

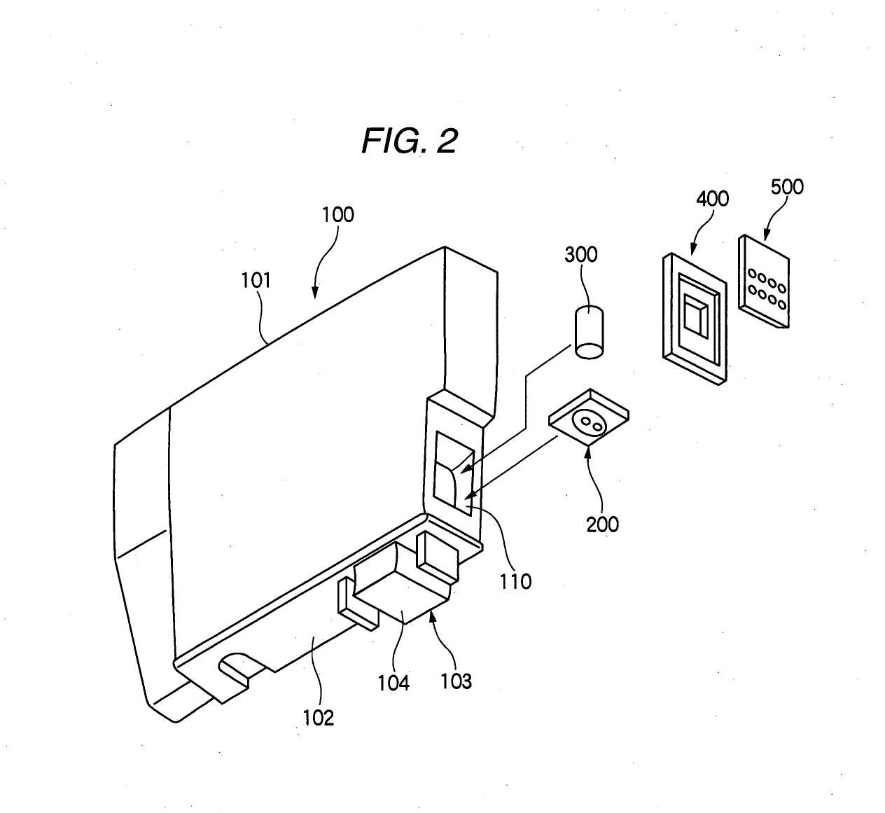

FIG. 2 is a perspective view showing the schematic configuration of the ink cartridge 100. A liquid detection device 200 that is a main part having a liquid detection function is incorporated into the ink cartridge 100.

The ink cartridge 100 has a cartridge case (container main body) 101, formed of resin, that has an ink storage portion (not shown) therein, and a cover 102, formed of resin, that is mounted to cover a lower end surface of the cartridge case 101. The cover 102 is provided to protect various seal films that are adhered to the lower end surface of the cartridge case 101. An ink delivery portion 103 is provided to protrude from the lower end surface of the cartridge case 101. A cover film 104 is adhered to a lower end surface of the ink delivery portion 103 so as to protect an ink delivery port (not shown).

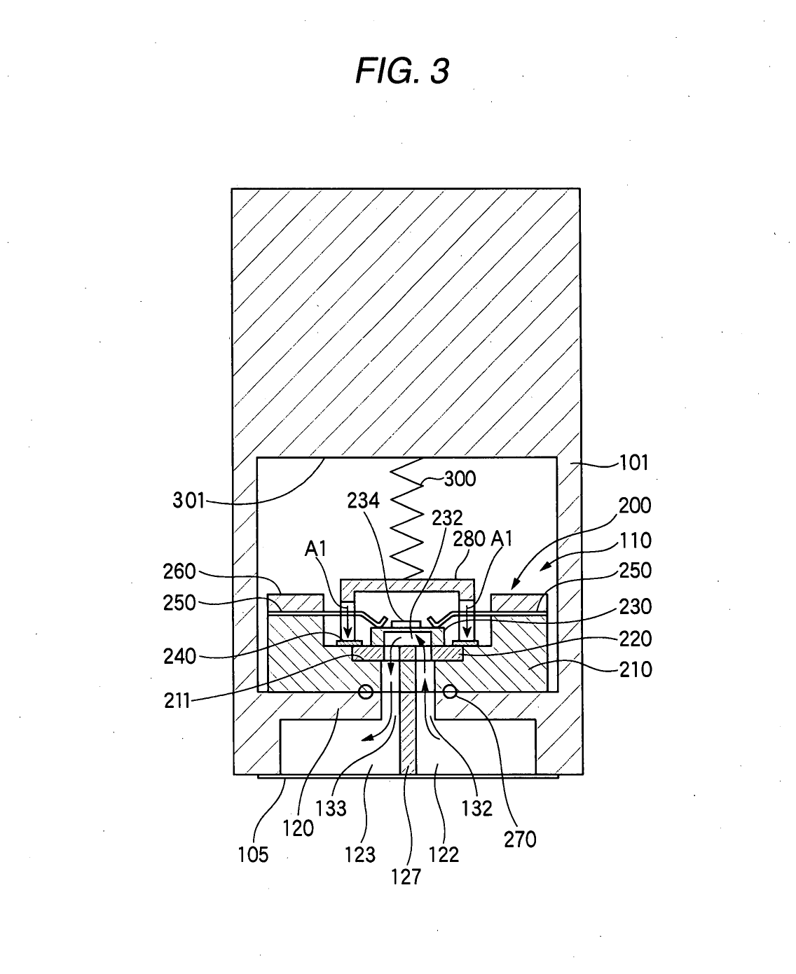

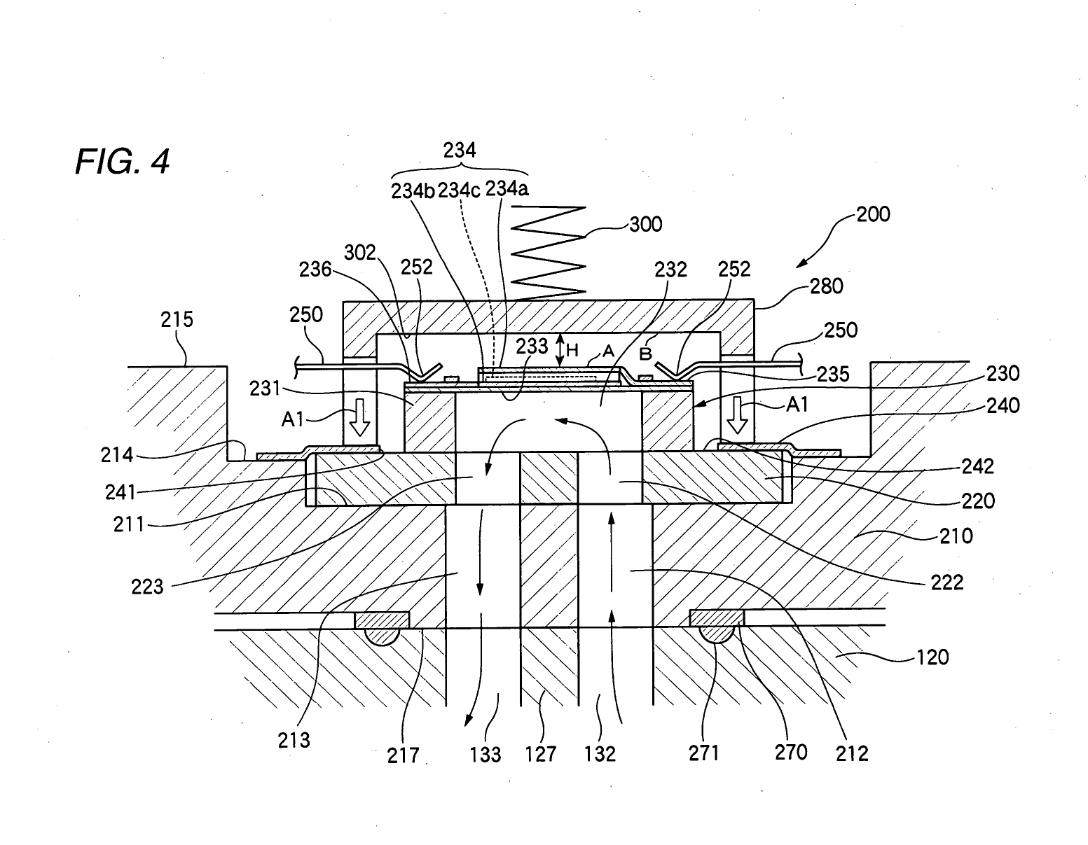

A sensor accommodating portion 110 that accommodates the liquid detection device 200 is provided on a side of the cartridge case 101 having a fine width. The liquid detection device 200 and a compressed coil spring (urging unit) 300 are accommodated in the sensor accommodating portion 110. As will be described below, the compressed coil spring (hereinafter, simply referred to as spring) 300 presses the liquid detection device 200 on a unit base receiving wall 120 (see FIGS. 3 and 4) of an inner bottom portion of the sensor accommodating portion 110 and crushes a sealing (see FIGS. 3 and 4) 270, thereby securing sealability between the liquid detection device 200 and the cartridge case 101.

The sensor accommodating portion 110 is opened in the side of the cartridge case 101 having a fine width, and the liquid detection device 200 and the spring 300 are inserted from the opening of the side. Then, the opening of the sensor accommodating portion 110 is closed by a seal cover 400, to which a board 500 is externally attached, in a state where the liquid detection device 200 and the spring 300 are accommodated therein.

FIG. 3 is a cross-sectional view of the first embodiment as viewed from the front surface (a delivery side of a recording paper) when the liquid detection device 200 and the spring are assembled into the sensor accommodating portion 110. FIG. 4 is an expanded cross-sectional view of the first embodiment.

Referring to FIG. 3, the unit base receiving wall 120 that receives a lower end of the liquid detection device 200, specifically, a unit base 210 of the liquid detection device 200 is provided in the inner bottom portion of the sensor accommodating portion 110 of the cartridge case 101. The liquid detection device 200 is placed on a flat top surface of the unit base receiving wall 120, and the sealing (ring-shaped seal member) 270 at the lower end of the liquid detection device 200 is pressed into contact with the unit base receiving wall 120 by an elastic force of the spring 300.

A pair of upstream and downstream sensor buffer chambers 122 and 123 are provided below the unit base receiving wall 120 to be divided in a horizontal direction with a partition wall 127 interposed therebetween. In addition, a pair of communicating ports (flow passages) 132 and 133 are provided in the unit base receiving wall 120 to correspond to the sensor buffer chambers 122 and 123. Though not shown, a delivery flow passage that delivers stored ink to the outside is provided in the cartridge case 101. The liquid detection device 200 is provided in the periphery of an end of the delivery flow passage (in the periphery of an ink delivery port).

In this case, the upstream sensor buffer chamber 122 communicates with an upstream delivery path through a connection hole (not particularly shown), and the downstream sensor buffer chamber 123 communicates with a downstream delivery path through a corresponding connection hole (similarly, not particularly shown). Further, the lower surfaces of the sensor buffer chambers 122 and 123 are opened, not closed by a rigid wall, and the opening is covered with a seal film 105 formed of resin.

The liquid detection device 200 of the first embodiment has a plate-shaped unit base 210, formed of resin, that has a concave place 211 at its top surface, a metallic plate sensor base 220 that is accommodated in the concave place 211 of the top surface of the unit base 210, a sensor chip 230 that is placed on and fixed to the top surface of the sensor base 220, an adhesive film 240 that adheres and fixes the sensor base 220 to the unit base 210, a pair of terminal plates 250 that are disposed above the unit base 210, a press member 260 (see FIG. 3; not shown in FIG. 4) of the terminal plates 250, and a sealing 270, formed of rubber, that is disposed on a lower surface of the unit base 210.

As shown in FIG. 4, the unit base 210 is a base substrate that supports the sensor base 220. The unit base 210 has the concave place 211 into which the sensor base 220 is fitted at a center of its top surface, and mounting walls 215 that are provided outside of a top surface wall 214 in the vicinity of the concave place 211 and are set higher than the top surface wall 214 by one step. Further, an entrance-side flow passage 212 and an exit-side flow passage 213 (liquid storage spaces) of circular through-holes are provided in a bottom wall of the concave place 211. In addition, a ring-shaped convex portion 217 that surrounds the sealing 270 is provided at the lower surface of the unit base 210 along the periphery, and the entrance-side flow passage 212 and the exit-side flow passage 213 are located between an inner circumferential surface of the convex portion 217 and the partition wall 127. Moreover, the sealing 270 is formed of a rubber ring packing, and has the ring-shaped convex portion 271 having a semicircular shape in section.

The sensor base 220 is formed of a metal plate, such as stainless or the like, having higher rigidity than resin for the sake of enhancing acoustic performance of the sensor. The sensor base 220 has an entrance-side flow passage 222 and an exit-side flow passage 223 (liquid storage spaces) of two through-holes to correspond to the entrance-side flow passage 212 and the exit-side flow passage 213 of the unit base 210.

An adhesive layer 242 is formed on the top surface of the sensor base 220, for example, by attaching a both-sided adhesive film or coating an adhesive. The sensor chip 230 is mounted on the adhesive layer 242 and then is fixed and adhered thereto. That is, the sensor base 220 is a base substrate that supports the sensor chip 230.

The sensor chip 230 has a sensor cavity 232 that receives ink (liquid) as a detection object. A bottom surface of the sensor cavity 232 is opened to receive ink, and a top surface thereof is closed by a vibrating plate 233. A piezoelectric element 234 is disposed on a top surface of the vibrating plate 233.

Specifically, the sensor chip 230 has a ceramic chip main body 231 that has the sensor cavity 232 of a circular opening as a center, the vibrating plate 233 that is laminated on a top surface of the chip main body 231 and closes the sensor cavity 232, the piezoelectric element 234 that is laminated on the vibrating plate 233, and terminals 235 and 236 that are laminated on the chip main body 231.

The piezoelectric element 234 has upper and lower electrode layers 234a and 234b that are connected to the terminals 235 and 236, respectively, and a piezoelectric layer 234c that is laminated between the upper and lower electrode layers 234a and 234b. The piezoelectric element 234 has a function of judging an ink end, for example, using a difference in electric characteristic by presence/absence of ink in the sensor cavity 232. Examples of a material for the piezoelectric layer 234c include lead zirconate titanate (PZT), lead lanthanum zirconate titanate (PLZT), and leadless piezoelectric film in which lead is not used.

The sensor chip 230 is integrally fixed to the sensor base 220 by the adhesive layer 242 by placing the lower surface of the chip main body 231 at a central portion of the top surface of the sensor base 220. The adhesive layer 242 also seals between the sensor base 220 and the sensor chip 230. Further, the entrance-side flow passages 222 and 212 and the exit-side flow passages 223 and 213 (liquid storage spaces) of the sensor base 220 and the unit base 210 communicate with the sensor cavity 232 of the sensor chip 230. With this configuration, ink enters the sensor cavity 232 through the entrance-side flow passages 212 and 222, and is discharged from the sensor cavity 232 through the exit-side flow passages 223 and 213.

Therefore, an ink detection flow passage from the communicating port 132 of the unit base receiving wall 120 to the exit-side flow passages 223 and 213 and the communicating ports 132 and 133 the unit base receiving wall 120 through the entrance-side flow passages 212 and 222 and the sensor cavity 232 constitutes a part of a delivery flow passage that delivers stored ink in the cartridge case to the outside. More specifically, the ink detection flow passage corresponds to a portion close to an exit of the delivery flow passage.

As such, the metallic sensor base 220, on which the sensor chip 230 is mounted, is accommodated in the concave place 211 of the top surface of the unit base 210. Then, the adhesive film 240 formed of resin is covered from the above, and then the sensor base 220 and the unit base 210 are adhered to each other as a single body.

The adhesive film 240 has an opening 241 at its center. The adhesive film 240 is covered from the above in a state where the sensor base 220 is accommodated in the concave place 211 of the top surface of the unit base 210, and the sensor chip 230 is exposed through the opening 241 at the center. Then, an inner circumference of the adhesive film 240 is adhered to the top surface of the sensor base 220 by the adhesive layer 242, and an outer circumference of the adhesive film 240 is adhered to the top surface wall 214 in the periphery of the concave place 211 of the unit base 210. That is, the adhesive film 240 is adhered over top surfaces of two parts (the sensor base 220 and the unit base 210. Accordingly, the sensor base 220 and the unit base 210 are fixed to each other and a space therebetween is sealed.

In this case, the top surface of the sensor base 220 protrudes above the top surface wall 214 in the vicinity of the concave place 211 of the unit base 210, and the adhesive film 240 is adhered to the top surface of the sensor base 220 at a position higher than an adhesion position to the top surface wall 214 of the unit base 210. As such, when the height of a film adhesion surface to the sensor base 220 is set to a position above the height of a film adhesion surface to the unit base 210, a step is formed. Accordingly, the sensor base 220 can be pressed by the adhesive film 240, and an adhesive force of the sensor base 220 to the unit base 210 can be improved. Further, rattle-free mounting can be performed.

Each terminal plate 250 has a spring piece 252 that is provided to protrude to a side edge of a bar-shaped longitudinal intermediate portion. The terminal plates 250 are disposed on the top surfaces of the mounting walls 215 of the unit base 210. Then, the press member 260 (see FIG. 3) is placed from the above, and the terminal plates 250 are interposed between the unit base 210 and the press member 260. In this state, the spring pieces 252 are in contact with and connected to the terminals 235 and 236 of the top surface of the sensor chip 230, respectively. Moreover, the press member 260 is a flat plate frame that is placed on the top surface of the mounting walls 215 of the unit 210 with the terminal plates 250 interposed therebetween.

As shown in FIG. 4, a sensor cover 280 is disposed above the sensor chip 230 so as not to come into contact with the sensor chip 230 and the spring pieces 252 of the terminal plates 250. The sensor cover 280 protects the sensor chip 230 and transfers the load (see FIG. 3; indicated by an arrow A1 in FIG. 4) of the spring 300 to the top surface of the sensor base 220 while sheering away from the sensor chip 230. A lower end of the sensor cover is placed above a portion to which the adhesive film 240 is attached, such that the load A1 of the spring 300 is applied to the sensor base 220 from the above of the adhesive film 240. If the load A1 of the spring 300 is applied to the sensor base 220, the load A1 is transferred to the underlying unit base 210 as it is, and acts as a force for crushing the sealing 270.

In this case, the sealing 270 is set to have a diameter as small as possible so as not to uselessly widen a seal space, and is located immediately below the sensor base 220 or the sensor chip 230. Accordingly, if the load A1 of the spring 300 is applied to the sensor base 220 having a small area, a pressing force of the spring 300 acts on the sealing 270 immediately below the sensor base 220.

The liquid detection device 200 of the first embodiment has the above configuration, and the liquid detection device 200 is accommodated in the sensor accommodating portion 110 of the cartridge case 101 shown in FIG. 2, together with the compressed spring 300. In this state, the spring 300 presses the sensor cover 280 downward, and thus the liquid detection device 200 is pressed into contact with the unit base receiving wall 120 in the sensor accommodating portion 110 while the sealing 270 provided on the lower surface of the unit case 210 is crushed, by the load A1 transferred to the unit base 210 through the sensor base 220. Accordingly, sealability between the liquid detection device 200 and the cartridge case 101 is secured.

With this assembling process, under a condition that sealability is secured, the upstream sensor buffer chamber 122 (see FIG. 3) in the cartridge case 101 (see FIG. 3) communicates with the entrance-side flow passages 212 and 222 in the liquid detection device 200 through the communicating port 132 of the unit base receiving wall 120, and the downstream sensor buffer chamber 123 (see FIG. 3) in the cartridge case 101 communicates with the exit-side flow passages 213 and 223 in the liquid detection device 200 through the communicating port 133 of the unit base receiving wall 120. Then, the entrance-side flow passages 212 and 222, the sensor cavity 232, and the exit-side flow passages 213 and 223 are disposed in serial in the delivery flow passage in the cartridge case 101 to be arranged in that order from the upstream side.

Here, an upstream flow passage that is connected to the sensor cavity 232 has the upstream sensor buffer chamber 122 having a large flow passage sectional area, the communicating port 132, and the entrance-side flow passages 212 and 222 having a small flow passage sectional area in the liquid detection device 200 (upstream small flow passages). Further, a downstream flow passage that is connected to the sensor cavity 232 has the downstream sensor buffer chamber 123 having a large flow passage sectional area, the communicating port 133, and the exit-side flow passages 213 and 223 having a small flow passage sectional area in the liquid detection device 200 (downstream small flow passages).

Next, a principle of ink detection by the liquid detection device 200 will be described.

When ink in the ink cartridge 100 is consumed, stored ink passes through the sensor cavity 232 of the liquid detection device 200 and is sent from the ink delivery portion 103 (see FIG. 2) to the recording head 12 (see FIG. 1) of the ink jet recording apparatus.

At this time, in a state where sufficient ink remains in the ink cartridge 100, the inside of the sensor cavity 232 is filled with ink. Meanwhile, if the ink residual quantity in the ink cartridge 100 is decreased, ink does not exist in the sensor cavity 232.

Here, the liquid detection device 200 detects a difference in acoustic impedance due to the state change. Accordingly, it can be detected whether sufficient ink remains or ink is consumed by a predetermined amount or more and the residual quantity is decreased.

Specifically, if a voltage is applied to the piezoelectric element 234, the deformation of the piezoelectric element 234 is accompanied by the vibrating plate 233. After the piezoelectric element 234 is forcibly deformed, if the application of the voltage is released, flexural vibration remains in the vibrating plate 233 for a while. The residual vibration is free vibration of the vibrating plate 233 and a medium in the sensor cavity 232. Therefore, if the voltage applied to the piezoelectric element 234 is a pulse wave or square wave, a resonance state of the vibrating plate 233 and the medium after the voltage is applied can be easily obtained.

The residual vibration is the vibration of the vibrating plate 233 and is accompanied by the deformation of the piezoelectric element 234. For this reason, the residual vibration is accompanied by the generation of a counter electromotive force by the piezoelectric element 234. The counter electromotive force is externally detected through the terminal plates 250.

Since a resonant frequency can be specified by the counter electromotive force detected in such a manner, the presence/absence of ink in the ink cartridge 100 can be detected on the basis of the resonant frequency. Moreover, the details of the detection principle have been described in JP-A-2001-146030, and thus the description thereof will be omitted herein.

When the ink residual quantity is detected according to such a principle, in order to accurately judge a difference in acoustic impedance on the basis of the amount of the ink residual quantity, it is necessary to make intensity of the vibration to be transferred to the vibrating plate 233 (FIG. 4) as large as possible. That is, if the vibrating plate 233 vibrates, a vibration wave is emitted from the vibrating plate 233 or the electrode 234a of the piezoelectric element 234, but the reflected wave from the inner surface of the sensor cover 280 vibrates the vibrating plate 233 or the electrode 234a. At this time, the distance H from the surface of the electrode 234a on the sensor cover 280 side (a rear surface A of a vibration wave emitting surface of the piezoelectric element 234) to the inner surface of the sensor cover 280 (a wall surface B facing the rear surface A) is excessively small, the vibration of the piezoelectric element 234 or vibrating plate 233 is attenuated by the reflected wave from the inner surface of the sensor cover 280 (wall surface B), which causes a decrease in counter electromotive force.

Accordingly, in this embodiment, when a wavelength of the vibration wave to be emitted from the piezoelectric element 234 is λ, the distance H between the rear surface A and the wall surface B is set to satisfy the following relationship.
(n×λ/2−λ/4−λ/8)≦H≦(n×λ/2−λ/4+λ/8) (Equation 1)
(where n=1, 2, 3, . . . )

In this embodiment, since the distance H is set to have a value according to the above relationship, there is little possibility that the vibration of the piezoelectric element 234 or the vibrating plate 233 is attenuated by a reflected wave, and the decrease of the counter electromotive force can be prevented. The detailed operation will be described below.

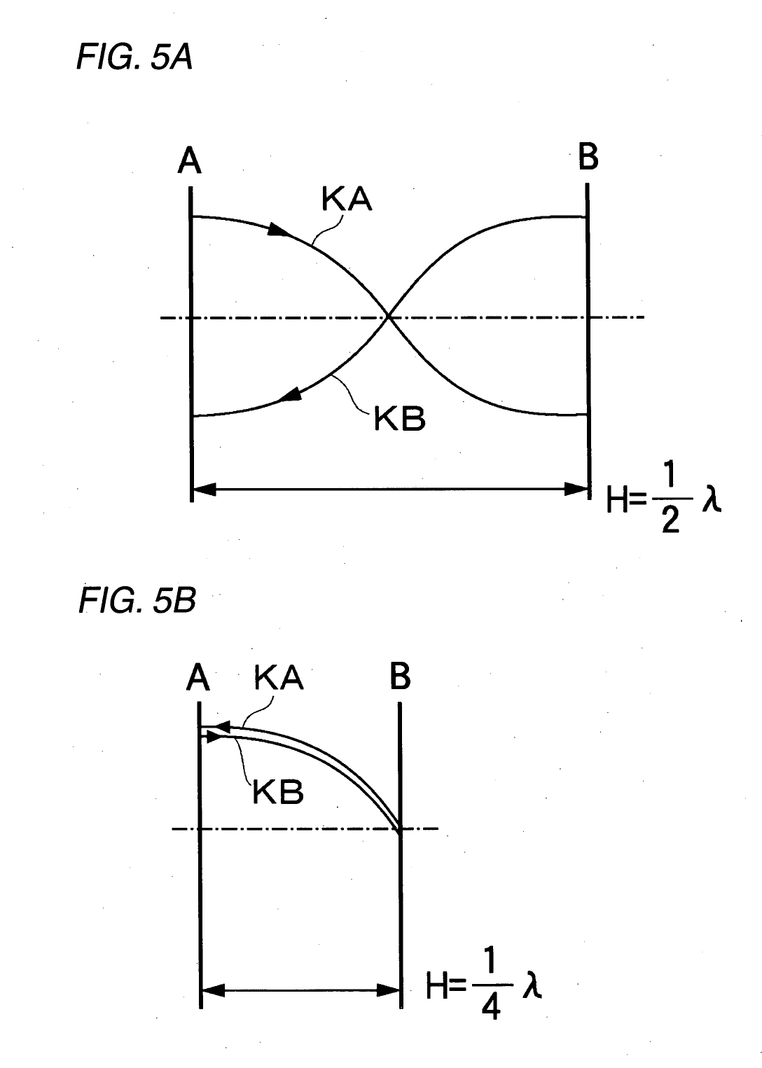

FIGS. 5A and 5B are diagrams showing the relationship between an outgoing wave KA and a reflected wave KB at the distance H between the rear surface A and the wall surface B. FIG. 5A shows a case where the condition H=λ/2 is satisfied, and FIG. 5B shows a case where the condition H=λ/4 is satisfied.

As shown in FIG. 5A, in the case of H=λ/2, the phase of the reflected wave KB from the wall surface B is opposite with respect to the outgoing wave KA emitted from the rear surface A, but the maximum amplitude is obtained. For this reason, the vibration of the piezoelectric element 234 or the vibrating plate 233 is cancelled by the reflected wave KB having an opposite phase to be then attenuated. The same is applied to a case where H is n times as much as λ/2 (where n=1, 2, 3, . . . ).

Meanwhile, as shown in FIG. 5B, in the case of H=λ/4, the reflected wave KB from the wall surface B is in phase with the outgoing wave KA emitted from the rear surface A. For this reason, even though the reflected wave KB returns to the rear surface A, the vibration of the piezoelectric element 234 or the vibrating plate 233 is not attenuated, but it is amplified. The same is applied to a case where H is (2n−1) times as much as λ/4 (where n=1, 2, 3, . . . ).

Accordingly, in order to prevent the reflected wave KB from attenuating the vibration of the piezoelectric element 234 or the vibrating plate 233, what is necessary is that the distance H is set in a range of ±λ/8 around H=(2n−1)×λ/4, which is half of λ/4 and n×λ/2. That is, if H falls within the range of (2n−1)×λ/4±λ/8, it can be seen that the attenuation of the vibration of the piezoelectric element 234 or the vibrating plate 233 can be reduced. Specifically, on the basis of this consideration, if the range of the distance H is set to satisfy Equation 1, there is little possibility that the vibration of the piezoelectric element 234 or the vibrating plate 233 attenuated by the reflected wave, and the decrease in the counter electromotive force can be prevented. Therefore, accurate detection of an ink residual quantity can be performed.

The liquid detection device 200 according to the first embodiment includes the unit base 210 to which the piezoelectric element 234 is attached, and the sensor cover 280 that presses the unit base 210 into contact with the unit base receiving wall 120 of the sensor containing portion 210 by the spring 300. Accordingly, the liquid detection device 200 can be separately assembled in advance, and then the liquid detection device 200 can be pressed by the spring 300 and mounted on the ink cartridge 100. Therefore, assembling can be simplified compared with a case where the liquid detection device 200 is bonded to the ink cartridge 100.

A variation in size between the liquid detection device 200 and the unit base receiving wall 120 can be absorbed by elasticity of the sealing 270, and thus reliable sealing can be performed through simple assembling. Further, the liquid storage space (the entrance-side flow passages 212 and 222 and the exit-side flow passages 213 and 223) sealed by the sealing 270 is secured in front of the sensor cavity 232 (opening side). Therefore, the liquid detection device 200 is rarely influenced by ink waves or bubbles in ink.

Since the pressing force by the spring 300 is applied to the unit base 210 through the sensor base 220, a surface pressure of a sealed surface between the sensor base 220 and the unit base 210 can be increased at the same time, and thus sealability between the sensor base 220 and the unit base 210 can be increased. That is, since the load of the spring 300 is applied to the adhesive film 240 at the top surface of the sensor base 220, the adhesive film 240 can be firmly adhered. From this viewpoint, it contributes to the improvement of sealability. Further, in this case, since a useless load is not applied to the sensor chip 230, the detection characteristic is not influenced.

The load A1 of the spring 300 is transferred to sensor base 220 through the sensor cover 280. Accordingly, the sensor chip 230 that is an essential part in view of vibration characteristics can be protected, and the selection of the spring 300 and the sensor base 220 can be freely determined, which results in ease of design.

The spring 300 is only accommodated in the sensor accommodating portion 110 in a compressed state. Accordingly, the spring 300 can be easily assembled together with the liquid detection device 200.

The adhesion and sealing of two parts (the metallic sensor base 220 and the resin unit base 210) can be simultaneously performed only by assembling the sensor base 220, on which the sensor chip 230 is mounted, into the unit base 210 from the above, and then attaching the adhesive film 240 over the top surfaces of the two parts, that is, the top surfaces of the sensor base 220 and the unit base 210. Therefore, excellent assembling workability is obtained. Further, since the adhesive film 240 is merely adhered over the two parts, sealing between the parts can be performed, without being influenced by accuracy in size of the individual parts.

In addition, for example, when the adhesive film 240 is heated and pressurized by a mass-production machine to be then welded, sealing performance can be enhanced only by controlling temperature or pressure by the mass-production machine. Therefore, stabilization when mass production can be achieved. Further, the adhesive film 240 that controls sealability is easily mounted and has spatial efficiency, and thus the liquid detection device 200 can be reduced in size.

The entrance-side flow passages 212 and 222 and the exit-side flow passages 213 and 223 to the sensor cavity 232 are formed in the sensor base 220 and the unit base 210, respectively. Further, ink flows into the sensor cavity 232 through the entrance-side flow passages 212 and 222 and is discharged through the exit-side flow passages 213 and 223. Therefore, ink flows in the sensor cavity 232 to the end, and thus erroneous detection due to the remaining liquid or bubbles in the sensor cavity 232 can be prevented.

The height of the adhesion surface of the adhesive film 240 to the unit base 210 is set to the position lower than the height of the adhesion surface to the sensor base 220, and thus the step is formed. Therefore, the sensor base 220 can be pressed by the adhesive film 240, and the adhesion of the sensor base 220 to the unit base 210 can be increased. Further, rattle-free mounting can be performed.

The liquid detection device 200 is disposed in the vicinity of the end of the delivery flow passage in the cartridge case 101, and the entrance-side flow passages 212 and 222, the sensor cavity 232, and the exit-side flow passages 213 and 223 of the liquid detection device 200 are provided in serial in the delivery flow passage to be arranged in that order from the upstream side. Therefore, the liquid residual quantity in the ink cartridge 100 can be accurately detected.

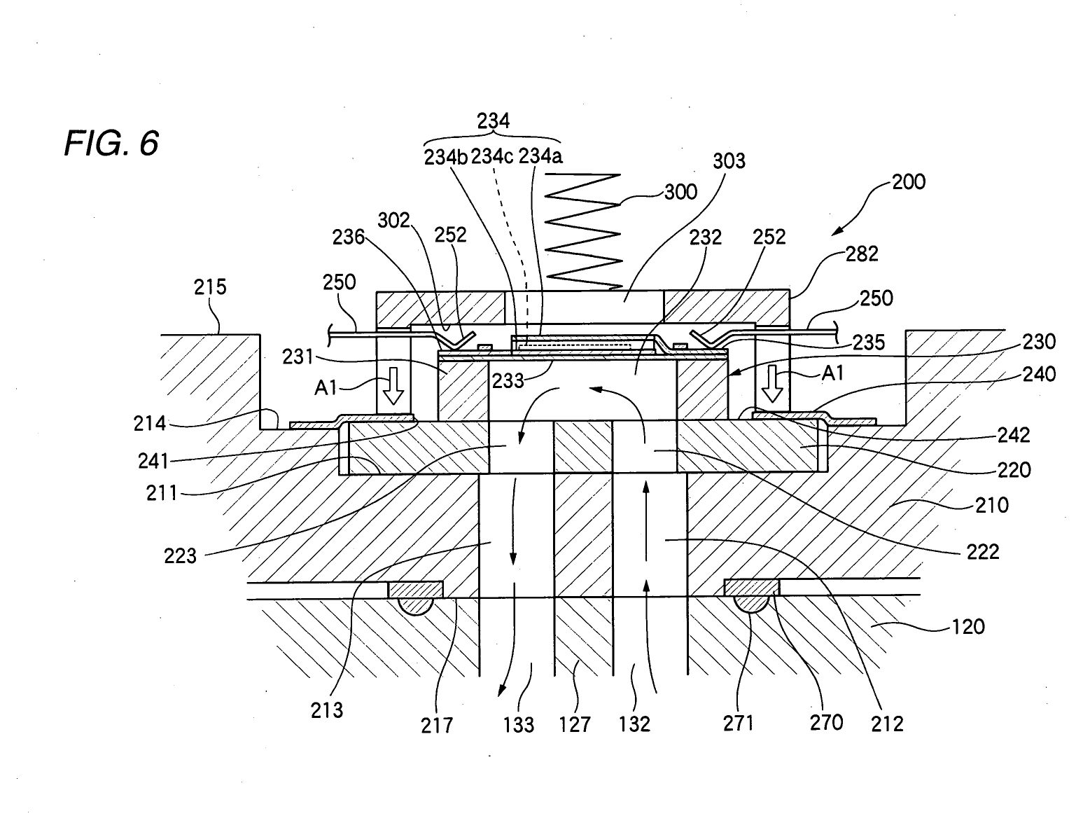

FIG. 6 is a cross-sectional view showing essential parts in a second embodiment of the invention, which corresponds to FIG. 4. In FIG. 6, the same parts as those in the first embodiment are represented by the same reference numerals as those in FIGS. 1 to 4, and the descriptions thereof will be omitted.

In the second embodiment, in order to make the total shape of the device compact, the sensor cover 282 is provided close to the piezoelectric element 234 compared with the case shown in FIG. 4. Further, the sensor cover 282 has an opening 303 that is formed larger than at least the external shape of the piezoelectric element 234 of the sensor chip 230 at its central portion. With the opening 303, like the first embodiment of FIG. 4, a large space on the side of the rear surface of the sensor chip 230 (the top surface of the piezoelectric element 234) is generated. Accordingly, there is little possibility that the vibration of the piezoelectric element 234 or the vibrating plate 233 is attenuated by the reflected wave, and the decrease of the counter electromotive force can be prevented. Therefore, accurate detection of the ink residual quantity can be performed.

The second embodiment has the same configuration as the first embodiment of FIG. 4, excluding that the sensor cover 282 is close to the piezoelectric element 234, and the sensor cover 282 has the opening 303. The second embodiment is effective when an installment space of the piezoelectric element 234 or the sensor cover 282 is not enough and the distance H of Equation 1 cannot be secured. Further, even when the installment space of the piezoelectric element 234 or the sensor cover 282 is temporarily enough, it is not necessary to secure the distance H of Equation 1. Accordingly, the installment space of the piezoelectric element 234 or the sensor cover 282 can be made small, and a degree of freedom for an installment position thereof can be increased. As a result, the liquid detection device can be reduced in size, and a degree of freedom for installment of the liquid detection device can be increased.

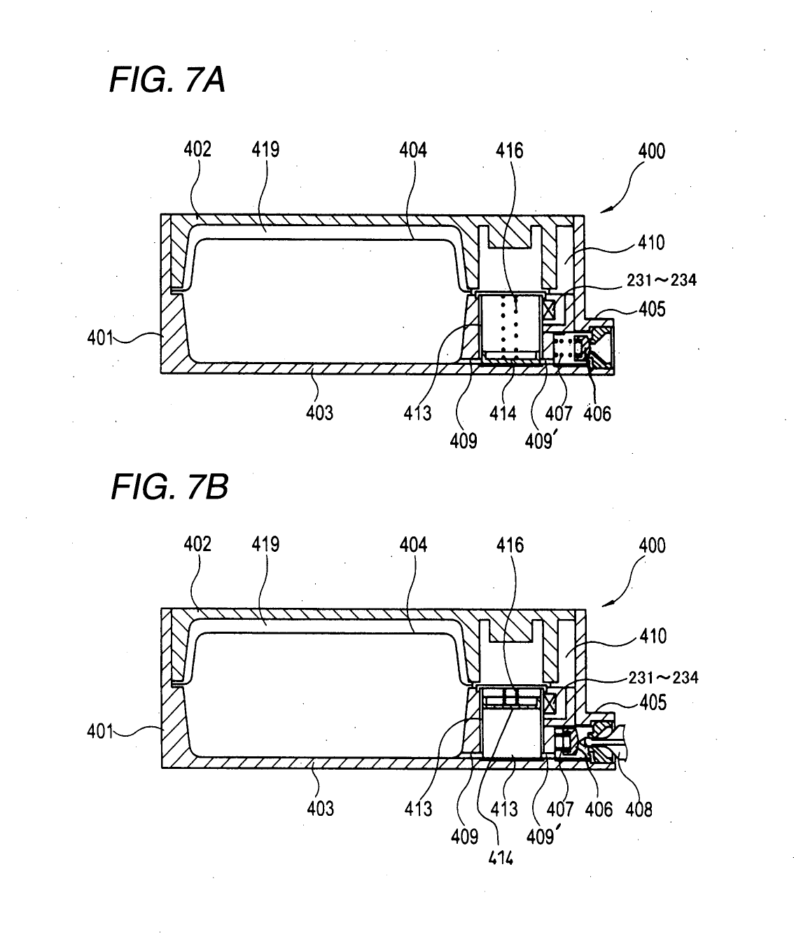

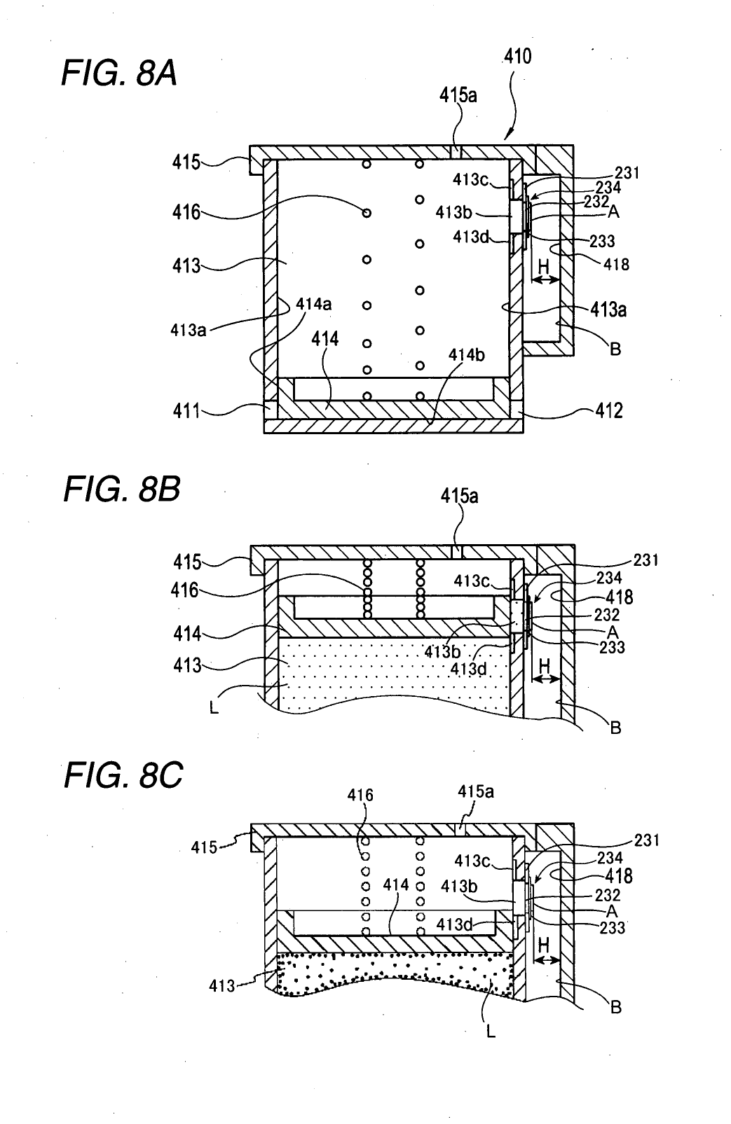

Next, a third embodiment will be described with reference to FIGS. 7 and 8. In FIGS. 7 and 8, the same parts as those in the first embodiment are represented by the same reference numerals as those in FIGS. 1 to 4, and the descriptions thereof will be omitted.

FIGS. 7(i) and 7(ro) respectively show the schematic configuration of an ink cartridge (liquid container) that has a liquid detection device according to a third embodiment of the invention. In this embodiment, a boxlike first case 401 having a bottom that is formed in a hemispheric shape and a second case 402 are united so as to form a case that constitutes a cartridge 400 serving as a liquid container. An opening formed in the first case 401, in which a liquid containing portion 403 containing a liquid, such as ink or the like, is to be formed, is covered with a flexible film body 404 formed of resin film, and the flexible film body 404 is bonded to the vicinity of the first case 401 by thermal welding. Meanwhile, on the other side of the flexible film body 404, the vicinity of the second case 402 is pressed into contact with the flexible film body 404 at a thermally welded portion of the flexible film body 404, thereby making a space between the second case 402 and the flexible film body 404 airtight. The airtight space becomes a pressurization region 419 that pressurizes the flexible film 404 by a pressurized fluid (pressurized air) introduced from the outside through a pressurized fluid introduction port (not shown) in a direction in which the liquid is discharged from the first case 401 to the outside.

A liquid supply port 405 that is connected to a liquid supply path of the liquid consuming apparatus is formed at an outer surface of the first case 401. In the liquid supply port 405, a packing that has an opening coming into elastic contact with the periphery of a liquid introduction member connected to the liquid ejection head of the liquid consuming apparatus, a valve body 406 that comes into contact with the top surface of the packing so as to seal an opening of the packing, and a spring 407, such as a coil spring or the like, which urges the valve body 406 toward the packing.

In a state where the connection to the liquid consuming apparatus (FIG. 7A) is not made, the valve is constantly opened by the spring 407. In a state where the connection is made (FIG. 7B), the valve body 406 is pressed by a liquid introduction member 408 in a direction in which the valve is opened, and then the valve is opened.

The liquid supply port 405 and the liquid containing portion 403 communicate with connection flow passages 409 and 409′, and the liquid detection device 410 is connected to parts of the connection flow passages.

FIG. 8 is a diagram showing the operation of a liquid detection device 410 in the third embodiment. When the connection to the liquid consuming apparatus is made, the liquid detection device 410 has an opening 411 that is connected to the liquid containing portion 403 at the bottom, a liquid detection chamber 413 that is a cylindrical container having an opening 412 to be connected to the liquid supply port 405, a moving body 414 that moves according to the liquid level along the inner surface of the liquid detection chamber 413 and acts as one wall of the liquid detection chamber 413, a cover 415 that seals the opening of the liquid detection chamber 413 and has an air communicating path 415a for communicating an upper portion of the liquid detection chamber 413, that is, a spatial region to the air, a compressed spring 416 serving as an urging unit that is provided between the cover 415 and the moving body 414 to press the moving body 414 downward with a weak force, and a piezoelectric element 234 that is provided to detect a prescribed liquid level.

Although the detailed description is omitted, the air communicating path 415a communicates with air through a capillary that is formed on a surface of the cover 415.

The moving body 414 functions as a piston. The moving body 414 has a bottom surface 414b that comes into contact with the liquid (ink) L entering the liquid detection chamber 413, and a side surface 414a that is provided on an outer circumference of the bottom surface 414b. The side surface 414a is provided along an inner surface 413a of the liquid detection chamber 413. A gap between the side surface 414a and the inner surface 413a of the liquid detection chamber 413 is set to an extent such that the moving body 414 can easily follow the liquid level and liquid leakage does not occur, specifically, such that a meniscus is formed. Further, the side surface 414a has a height enough to maintain a vertical state with respect to the inner surface 413a. The bottom surface 414b is formed to have a size enough to cover the entire liquid level.

The compressed spring 416 urges the moving body 414 toward the bottom of the liquid detection chamber 413. An urging force of the compressed spring 416 is set to an extent such that liquid leakage does not occur from the gap between the inner surface 413a of the liquid detection chamber 413 and the side surface 414a of the moving body 414, that is, to an intensity such that the moving body 414 is not immersed in the liquid L by the urging force. Moreover, instead of the compressed spring 416, an elastic member, such as rubber or a plate spring, may be used. Further, the moving body 414 may be urged toward the bottom of the liquid detection chamber 413. Therefore, if the moving body 414 has an appropriate weight, gravity that acts on the moving body 414 can be used as the urging force, without using the elastic member, such as the compressed spring, rubber, or the plate spring.

The piezoelectric element 234 is fixed to an outer surface of the liquid detection chamber 413. The piezoelectric element 234 is provided to cover a concave portion 413b that is provided at a portion of the wall of the liquid detection chamber 413. The concave portion 413b is formed at a place where it faces the side surface 414a of the moving body 414 when the liquid L enters the liquid detection chamber 413 and the liquid level rises. Moreover, the structure of the piezoelectric element 234 is the same as the piezoelectric element 234 of the first embodiment described above.

If the ink cartridge 400 is mounted on a recording apparatus as a liquid consuming apparatus, as shown in FIG. 7B, the liquid introduction member 408 is engaged with the liquid supply port 405, and the valve body 406 is retreated. Further, a pressurized fluid supply source (not shown) communicates with the pressurization region 419.

In a state where air as the pressurized fluid is not supplied to the pressurization region 419, as shown in FIG. 8A, the moving body 414 suffers the urging force of the compressed spring 416 and is then located at the bottom of the liquid detection chamber 413.

Next, in this state, if air is supplied from the pressurized fluid supply source, as shown in FIG. 7B, air flows in the pressurization region 419 that is defined by the flexible film body 404 and the second case 402, and the liquid containing portion 403 is pressurized by the flexible film body 404. Accordingly, ink in the liquid containing portion 403 flows into the liquid detection chamber 413 through the connection flow passage 409. As ink enters, the moving body 414 ascends according to the rise of the liquid level while discharging upper air from the air communicating flow passage 415a. Then, as shown in FIG. 8B, the moving body 414 faces the concave portion 413b. Pressurized ink through the above process flows from the gap between the side surface 414a of the moving body 414 and the inner surface 413a of the liquid detection chamber 413 into the concave portion 413b and the sensor cavity 232 by a capillary phenomenon or the like. Accordingly, the moving body 414 faces the vibrating plate 233 with ink filled in the concave portion 413b and the sensor cavity 234 interposed therebetween. That is, the concave portion 413b and the sensor cavity 232 are sealed by the moving body 414 in a state where ink is filled therein. Moreover, minute grooves 413c and 413d that communicate with the concave portion 413b upward and downward are preferably formed in an up and down direction such that ink can easily enter the concave portion 413b and the sensor cavity 232. Further, even when the liquid level exceeds a prescribed position and rises above the concave portion 413b, ink enters the concave portion 413b and the sensor cavity 232, and the concave portion 413b and the sensor cavity 232 are sealed by the moving body 414 in a state where ink is filled therein.

Next, if ink L in the liquid containing portion 403 is little as ink is consumed, even though pressurized air is supplied from the pressurized fluid supply source, ink L does not flow in the liquid detection chamber 413. For this reason, ink L of the liquid detection chamber 413 cannot keep a predetermined level, and the liquid level gradually falls. Accordingly, the moving body 414 follows the liquid level and moves downward. Then, when the groove 413b is not provided, ink in the concave portion 413b and the sensor cavity 232 flows out downward from the gap between the side surface 414a of the moving body 414 and the inner surface 413a of the liquid detection chamber 413. Further, when the groove 413b is provided, ink in the concave portion 413b and the sensor cavity 232 flows out downward through the groove 413b serving as a flow passage. Thereafter, air flows in the concave portion 413b and the sensor cavity 232. In addition, if the liquid level falls and, as shown in FIG. 8C, the moving body 414 moves below the concave portion 413b, ink in the concave portion 413b and the sensor cavity 232 completely flows out, and the vibrating plate 233 is exposed to air.

In the liquid detection device 410 of this embodiment, as described above, the state of the sensor cavity 232 changes, and thus, according to the same principle as the first embodiment, it is possible to detect whether ink sufficiently remains or ink is consumed by a predetermined amount or more and the residual quantity is small.

In addition, in the liquid detection device 410 of this embodiment, a wall surface 418 that constitutes a portion of the cartridge case is formed to face the piezoelectric element 234 or the vibrating plate 233. Then, like the first embodiment, the distance H from the surface of the electrode of the piezoelectric element 234 on the wall surface 418 side (the rear surface A of the vibration wave emitting surface of the piezoelectric element 234) to the inner surface of the wall surface 418 (the wall surface B facing the rear surface A) is set by the relationship of Equation 1 described in the first embodiment.

With this configuration, like the liquid detection device 200 according to the first embodiment, there is little possibility that the vibration of the piezoelectric element 234 or the vibrating plate 233 is attenuated by the reflected wave from the wall surface 418, and the decrease of the counter electromotive force can be prevented. Accordingly, accurate detection of the ink residual quantity can be performed.

The invention is not limited to the above-described embodiments, but various modifications can be made within the scope without departing from the spirit of the invention. For example, the following modifications can be made.

Although the liquid detection device 200 or 410 is accommodated in the ink cartridge 100 or 400 as a liquid container in the above-described embodiments, the liquid detection device 200 or 410 may be attached outside the liquid container. Further, the liquid detection device 200 or 410 may be provided in a liquid ejection apparatus, not in the liquid container. In summary, the liquid detection device 200 or 410 may be connected to the liquid containing portion so as to detect the liquid therein.

In the above-described embodiments, the ink cartridge 100 or 400 as a liquid container is detachably mounted on the carriage 1 of the ink jet recording apparatus as a liquid ejection apparatus. Then, the ink is supplied from the ink cartridge 100 or 400 to the recording head 12. Alternatively, ink may be supplied from the liquid containing portion provided outside an ink jet recording apparatus to the recording head 12.

What is claimed is:

1. A liquid detection device that is accommodated in a sensor accommodating portion formed in a liquid container containing a liquid therein and detects the liquid in the liquid container using a piezoelectric element,
wherein, when a wavelength of a vibration wave to be emitted from the piezoelectric element is λ, a distance H from a rear surface of a vibration wave emitting surface of the piezoelectric element to a wall surface facing the rear surface is represented by Equation 1.
(n×λ/2−λ/4−λ/8)≦H≦(n×λ/2−λ/4+λ/8) (Equation 1)
(where n=1, 2, 3, . . . )

2. The liquid detection device according to claim 1, further comprising:
a unit base to which the piezoelectric element is attached; and
a sensor cover that presses the unit base into contact with a unit base receiving wall of the sensor accommodating portion by an urging unit,
wherein an inner surface of the sensor cover facing the piezoelectric element becomes the wall surface.

3. The liquid detection device according to claim 1,
wherein a wall of the sensor accommodating portion becomes the wall surface facing the rear surface of the vibration wave emitting surface of the piezoelectric element.

4. A liquid container comprising:
a liquid containing portion that stores a liquid therein;
a liquid supply port that communicates with the liquid containing portion and supplies the liquid to an external liquid consuming apparatus;
a liquid detection device that is connected to the liquid containing portion and the liquid supply port, and detects the liquid,
wherein the liquid detection device is the liquid detection device according to claim 1.

5. A liquid ejection apparatus on which the liquid container according to claim 4 is detachably mounted.

6. A liquid detection device that is accommodated in a sensor accommodating portion formed in a liquid container containing a liquid therein and detects the liquid in the liquid container,
wherein an opening that is larger than at least an external shape of the piezoelectric element is provided at a wall surface facing a rear surface of a vibration wave emitting surface of the piezoelectric element.

7. The liquid detection device according to claim 6, further comprising:
a unit base to which the piezoelectric element is attached; and
a sensor cover that presses the unit base into contact with a unit base receiving wall of the sensor accommodating portion by an urging unit,
wherein an inner surface of the sensor cover facing the piezoelectric element becomes the wall surface.

8. The liquid detection device according to claim 6,
wherein a wall of the sensor accommodating portion becomes the wall surface facing the rear surface of the vibration wave emitting surface of the piezoelectric element.

9. A liquid container comprising:
a liquid containing portion that stores a liquid therein;
a liquid supply port that communicates with the liquid containing portion and supplies the liquid to an external liquid consuming apparatus;
a liquid detection device that is connected to the liquid containing portion and the liquid supply port, and detects the liquid,
wherein the liquid detection device is the liquid detection device according to claim 6.

10. A liquid ejection apparatus on which the liquid container according to claim 9 is detachably mounted.

11. A liquid detection device that is connected to a liquid containing portion containing a liquid therein and detects the liquid in the liquid containing portion using a piezoelectric element, the liquid detection device comprising:
a sensor cavity that receives the liquid;
a vibrating plate that closes an opening of the sensor cavity; and
a piezoelectric element that is provided at a surface of the vibrating plate opposite to the sensor cavity,
wherein a wall surface facing a rear surface of a vibration wave emitting surface of the piezoelectric element is provided, and
when a wavelength of a vibration wave to be emitted from the piezoelectric element is λ, a distance H from the rear surface to the wall surface is represented by Equation 1.
(n×λ/2−λ/4−λ/8)≦H≦(n×λ/2−λ/4+λ/8) (Equation 1)
(where n=1, 2, 3, . . . )

12. A liquid container comprising:
a liquid containing portion that stores a liquid therein;
a liquid supply port that communicates with the liquid containing portion and supplies the liquid to an external liquid consuming apparatus;
a liquid detection device that is connected to the liquid containing portion and the liquid supply port, and detects the liquid,
wherein the liquid detection device is the liquid detection device according to claim 11.

13. The liquid container according to claim 12, further comprising:
a sensor accommodating portion that accommodates the liquid detection device;
a unit base to which the piezoelectric element is attached; and
a sensor cover that presses the unit base into contact with a unit base receiving wall of the sensor accommodating portion by an urging unit,
wherein an inner surface of the sensor cover facing the piezoelectric element becomes the wall surface.

14. The liquid container according to claim 12, further comprising:
a sensor accommodating portion that accommodates the liquid detection device,
wherein a wall of the sensor accommodating portion becomes the wall surface that faces the rear surface of the vibration wave emitting surface of the piezoelectric element.

15. A liquid ejection apparatus that is supplied with a liquid from a liquid containing portion containing the liquid therein, the liquid ejection apparatus comprising:
a liquid detection device that is connected to the liquid containing portion and detects the liquid,
wherein the liquid detection device is the liquid detection device according to claim 11.

16. The liquid ejection apparatus according to claim 15, further comprising:
a sensor accommodating portion that accommodates the liquid detection device;
a unit base to which the piezoelectric element is attached; and
a sensor cover that presses the unit base with a unit base receiving wall of, the sensor accommodating portion by an urging unit,
wherein an inner surface of the sensor cover facing the piezoelectric element becomes the wall surface.

17. The liquid ejection apparatus according to claim 15, further comprising:
a sensor accommodating portion that accommodates the liquid detection device,
wherein a wall of the sensor accommodating portion becomes the wall surface that faces a rear surface of a vibration wave emitting surface of the piezoelectric element.

18. A liquid detection device that is connected to a liquid containing portion containing a liquid therein and detects the liquid in the liquid containing portion using a piezoelectric element, the liquid detection device comprising:
a sensor cavity that receives the liquid;
a vibrating plate that closes an opening of the sensor cavity; and
a piezoelectric element that is provided at a surface of the vibrating plate opposite to the sensor cavity,
wherein a wall surface facing a rear surface of a vibration wave emitting surface of the piezoelectric element is provided, and
an opening that is larger than at least an external shape of the piezoelectric element is provided at the wall surface.

19. A liquid container comprising:
a liquid containing portion that stores a liquid therein;
a liquid supply port that communicates with the liquid containing portion and supplies the liquid to an external liquid consuming apparatus;
a liquid detection device that is connected to the liquid containing portion and the liquid supply port, and detects the liquid,
wherein the liquid detection device is the liquid detection device according to claim 18.

20. The liquid container according to claim 19, further comprising:
a sensor accommodating portion that accommodates the liquid detection device;
a unit base to which the piezoelectric element is attached; and
a sensor cover that presses the unit base into contact with a unit base receiving wall of the sensor accommodating portion by an urging unit,
wherein an inner surface of the sensor cover facing the piezoelectric element becomes the wall surface.

21. The liquid container according to claim 19, further comprising:
a sensor accommodating portion that accommodates the liquid detection device,
wherein a wall of the sensor accommodating portion becomes the wall surface that faces a rear surface of a vibration wave emitting surface of the piezoelectric element.

22. A liquid ejection apparatus that is supplied with a liquid from a liquid containing portion containing the liquid therein, the liquid ejection apparatus comprising:
a liquid detection device that is connected to the liquid containing portion and detects the liquid,
wherein the liquid detection device is the liquid detection device according to claim 18.

23. The liquid ejection apparatus according to claim 22, further comprising:
a sensor accommodating portion that accommodates the liquid detection device;
a unit base to which the piezoelectric element is attached; and
a sensor cover that presses the unit base with a unit base receiving wall of the sensor accommodating portion by an urging unit,
wherein an inner surface of the sensor cover facing the piezoelectric element becomes the wall surface.

24. The liquid ejection apparatus according to claim 22, further comprising:
a sensor accommodating portion that accommodates the liquid detection device,
wherein a wall of the sensor accommodating portion becomes the wall surface that faces a rear surface of a vibration wave emitting surface of the piezoelectric element.
